(19) United States
(12) Patent Application Publication
(10) Pub. No.: US 2011/0038243 A1
(43) Pub. Date: Feb. 17, 2011

(54) METHOD FOR CALIBRATING OFFSET OF MICRO ACTUATOR

(76) Inventors: I-Bing Su, Taoyuan County (TW); Chi-Hsiang Kuo, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/854,867

(22) Filed: Aug. 11, 2010

(30) Foreign Application Priority Data
Aug. 17, 2009 (TW) 098127669

(51) Int. Cl. G11B 27/36

(52) U.S. Cl. 369/53.25; G9B/27.052

(57) ABSTRACT

A method for calibrating the offset of a micro actuator includes: setting a reference reflective plane with different focus voltage levels; focusing on test points on the reference reflective plane and recording the tracking voltages; selecting a standard focus voltage level; calculating the offset of the tracking voltage for each test point; curve-fitting the offsets into a tracking voltage curve for each focus voltage level; and acquiring an offset of a selected tracking voltage by interpolation or extrapolation to calibrate the selected tracking voltage.

### BACKGROUND OF THE INVENTION

1. Field of the Invention

The present invention relates to optical disc drives, and more particularly, to a micro actuator of an optical pickup head within an optical disc drive, wherein the micro actuator is used to calibrate an offset of the tracking voltage of an objective lens.

2. Description of the Prior Art

An optical pickup head utilizes a micro actuator to carry an objective lens, to control the magnitude of a supply voltage in order to provide a corresponding electromagnetic force, and to drive the objective lens in the magnetic field horizontally and/or vertically, to thereby make the laser beams projected by the objective lenses focus on an optical disc for executing reading/writing operations of the optical disc.

Please refer to FIG. 1; a micro actuator is illustrated according to the conventional art. In FIG. 1, a micro actuator 1 includes a base 2, and there are four elastic metal wires 3 connected between two sides of the base 2 and two sides of the supporter 4. The supporter 4 is accommodated at the base 2 by the metal wires 3 in a manner of movements. The objective lens 5, used for projecting the laser beams, is positioned at the central part of the supporter 4. Horizontal electromagnetic coils 6 are winded at the surroundings of the supporter 4, and vertical electromagnetic coils 7 are placed at the front side and back side of the supporter 4. The base 2 is disposed on the L-shaped backboard 8, wherein two magnetic bulks 9 are placed at two ends of the backboard 8 respectively, to allow the supporter 4 to be placed between the two magnetic bulks 9. The micro actuator 1 controls the voltage magnitudes corresponding to the horizontal electromagnetic coils 6 and the vertical electromagnetic coils 7 to form electromagnetic forces at different directions. These interact with the magnetic force formed by the magnetic bulks 9 to thereby drive the supporter 4 to move against the elasticity of the four metal wires 3 along a focus direction F or along a tracking direction T.

Please refer to FIG. 2. FIG. 2 is a diagram illustrating the objective lens 5 being shifted by the control of the micro actuator accordingly. Conventionally, the micro actuator 1 is placed inside the optical pickup head 10, and the micro actuator 1 is roughly moved around the location of the read/write target in by the movement of the optical pickup head 10. Then, the micro actuator 1, which uses the electromagnetic forces generated by the voltage, may move against the elasticity of the metal wires 3 to slightly shift the objective lens 5. Since the elasticity of the metal wires 3 is proportional to the electromagnetic force corresponding to the voltage, the micro actuator 1 may control the objective lens 5 to move to the target location along the tracking direction T by applying a particular tracking voltage Tvn at the tracking direction T for moving the objective lens 5 to a location apart from a central location to thereby control the objective lens 5 to shift to the determined location at the tracking direction T. The objective lens 5 is at the central location when the applied voltage is Tv0. Similarly, the focus of the objective lens 5 may be controlled to shift along the focus direction F proportional to an applied particular focus voltage Fv, to thereby orientate/focus to a target location accordingly.

Due to fabrication errors, the asymmetric character of the metal wires, bad winding quality of the coils, and the interactions between the electromagnetic coils, the objective lens 5 cannot be moved in proportion to the applied voltage, especially when the objective lens 5 is moved to peripheral areas having larger magnetic variations. Thereby the objective lens 5, at different focus voltage levels Fv0, Fv1, and Fv2 under the same magnitude of the tracking voltage Tvn will be shifted to different distances d1, d2, d3 respectively, leading to shifted offsets at the tracking direction T. Even if the aforementioned offsets can be eliminated by using the tracking errors to make the objective lens 5 shift to the determined location accurately under a closed-loop control, when the objective lens 5 is under an open-loop control, the shifted errors at the tracking direction T will not be eliminated automatically, especially when executing the process of making the label pattern at the label side by the tracking server. This will lead to an inaccuracy of the objective lens 5, failure to reach the accuracy requirement of the reading/writing operations of the optical pickup head, and will further destroy the label pattern. Therefore, calibration methods for promoting the accuracy of tracking the objective lens by the micro actuator are demanded.

### SUMMARY OF THE INVENTION

It is therefore, an objective of the present invention to provide a method for calibrating an offset of a micro actuator. The method comprises: acquiring offsets corresponding to each test point of a reference reflective plane at different heights by comparing the tracking voltage of each of the test points with a tracking voltage of a standard reference reflective plane; curve-fitting a tracking voltage curve correspondingly; and calibrating the offsets of each of the tracking voltages at different locations of the tracking direction T, to promote the tracking accuracy of the micro actuator.

According to another objective of the present invention, a method for calibrating an offset of a micro actuator is provided. The method comprises: acquiring an offset of a tracking voltage by interpolating or extrapolating the tracking voltage curves according to the tracking voltages and focus voltages of the micro actuator, to calibrate the tracking voltage according to the offset for promoting the accurateness of the label pattern.

The method of an exemplary embodiment of the present invention comprises the following steps: setting a reference reflective plane with a plurality of focus voltage levels; focusing on each of a plurality of predetermined test points at the reference reflective plane respectively, and recording the tracking voltage of each of the test point; selecting a focus voltage level of the reference reflective plane as a standard focus voltage level; calculating offsets of the tracking voltage of the test points corresponding to other focus voltage levels of the reference reflective plane, respectively, by comparing with the tracking voltages of the test points at the standard focus voltage level; curve-fitting the offsets of the tracking voltage of the test points into tracking voltage curves corresponding to each focus voltage level according to the tracking voltage of the standard focus voltage level; and acquiring an offset of a selected tracking voltage by interpolating or extrapolating the tracking voltage curves to calibrate the selected tracking voltage.

The method for calibrating an offset of the micro actuator of the present invention selects a focus voltage level with a zero absolute focus voltage or a smallest absolute focus voltage as the standard focus voltage level. An offset of the driven tracking voltage is acquired by calibrating a driven tracking voltage by interpolating or extrapolating tracking voltage curves adjacent to a driven focus voltage of the objective lens according to the driven tracking voltage. Then a label pattern of a label side of the optical disc is printed by utilizing calibrated driven tracking voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three-dimensional diagram of a conventional micro actuator according to the prior art.

FIG. 2 is a diagram illustrating offsets of tracking voltages of the micro actuator according to the prior art.

FIGS. 3-5 are diagrams illustrating processes for forming the tracking voltage curve according to an exemplary embodiment of the present invention.

FIG. 6 is a diagram illustrating a plurality of tracking voltage curves corresponding to the focus voltages respectively according to an exemplary embodiment of the present invention.

FIG. 7 is a diagram illustrating a flow chart for calibrating offsets of a micro actuator according to an exemplary embodiment of the present invention.

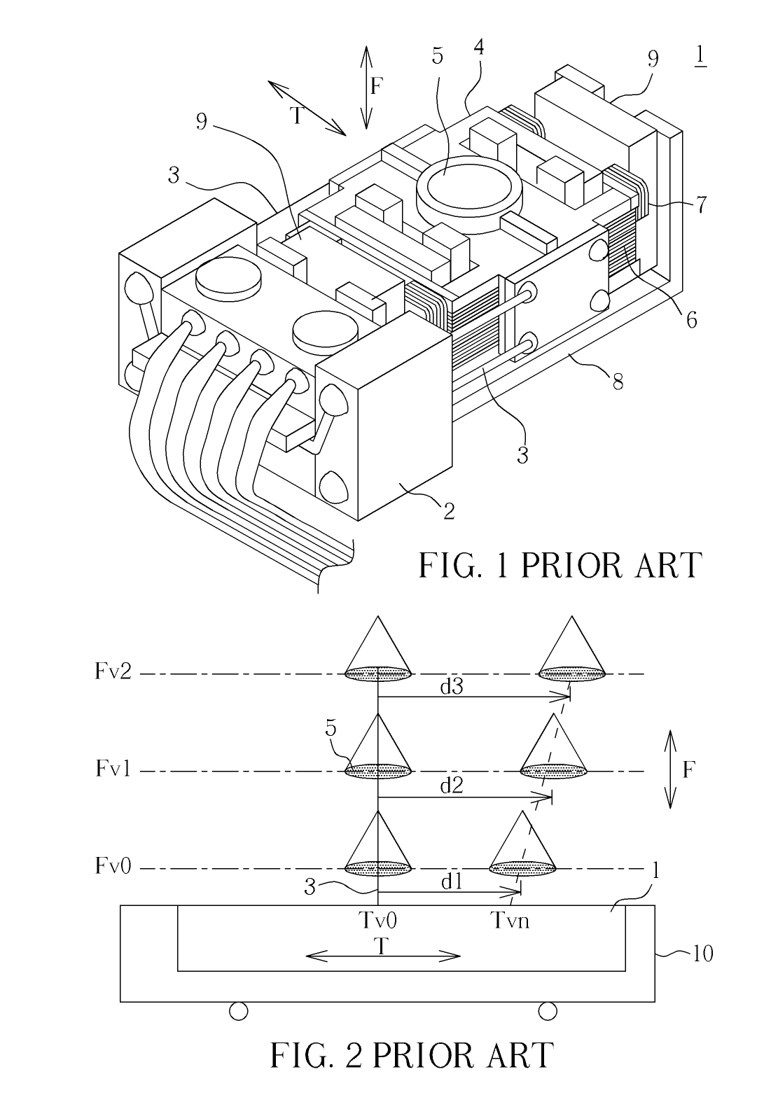

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

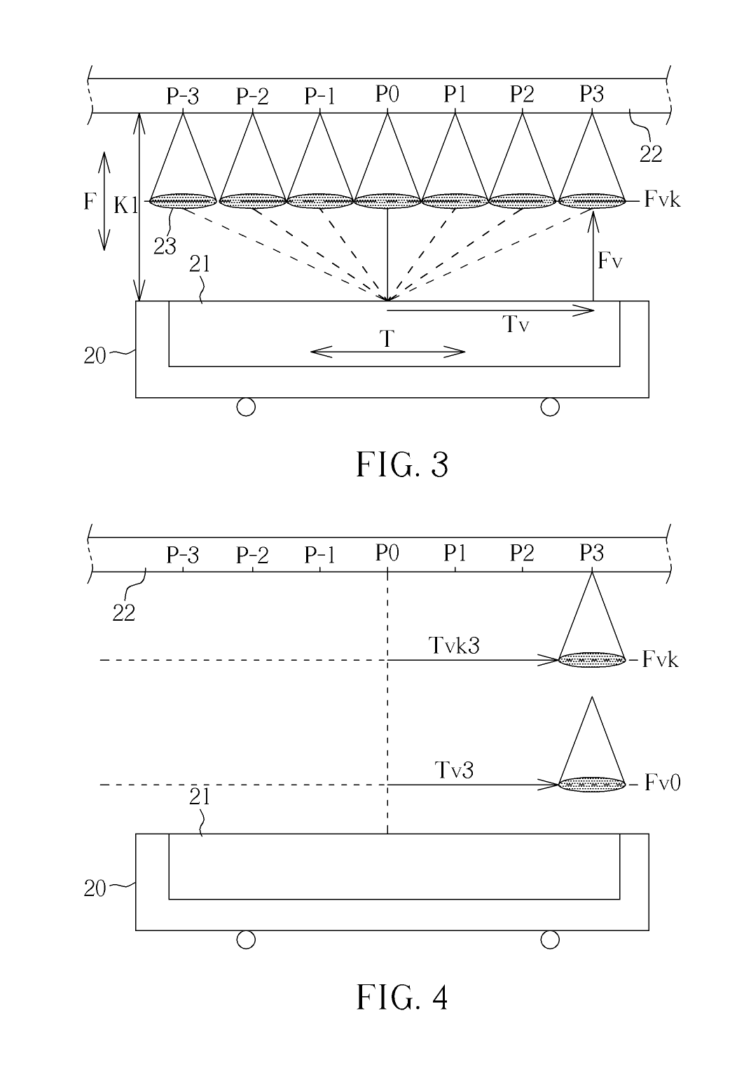

Please refer to FIGS. 3-5. FIGS. 3-5 are diagrams illustrating technological process for forming a tracking voltage curve of a micro actuator according to an exemplary embodiment of the present invention. As shown in FIG. 3, the optical pickup head 20 moves the micro actuator 21 around reference reflective plane 22 to make the micro actuator 21 face the reference reflective plane 22. The reference reflective plane 22 can be a normal reflective layer or a data layer of an optical disc, and the reference reflective plane 22 is apart from the micro actuator 21 by a distance K along the focus direction F. A plurality of test points P are set at the reference reflective plane 22, wherein distances between each two adjacent test points of the test points can be equidistant or not equidistant. In an exemplary embodiment, as shown in FIG. 3, distances of seven test points P-3, P-2, P-1, P0, P1, P2, and P3 are equal. Under an open-loop tracking where the optical pickup head 20 is static, the micro actuator 21 drives the objective lens 23 to the seven test points respectively, and focuses the objective lens 23 on the reference reflective plane 22. As mentioned above, since a distance between the micro actuator 21 and the reference reflective plane 22 is K, and a corresponding height of each of the test points to the objective lens 23 is the same as that of other test points at the focus direction F, each required focus voltage Fv for each test point is a same focus voltage level Fvk. Each tracking voltage Tv of the test points with a corresponding focus voltage level Fvk of the reference reflective plane 22 respectively is measured and recorded.

The reference reflective plane 22 is shifted to a plurality of focus voltage levels each with a predetermined height: K1 . . . Kn respectively, and the aforementioned focusing, measuring, and recording steps are repeated respectively. At the reference reflective plane 22 at each predetermined height, the objective lens 23 is driven to each of the seven test points by the micro actuator 21, to focus and record the corresponding tracking voltage of each test point and the corresponding focus voltage level Fvk of the reference reflective plane 22.

A correct relation between the tracking voltage Tv and a shifted distance of the objective lens 23 can be found when a voltage magnitude of the focus voltage Fv is zero. This is because the magnetic influences upon the tracking voltage Tv at the tracking direction T are minute when the focus voltage Fv is zero. Hence, a focus voltage level Fv0 having a zero focus voltage is applied as the standard focus voltage level to measure the data corresponding to other focus voltage levels. The measured data corresponding to focus voltage levels having predetermined heights are compared with the data corresponding to the standard focus voltage level Fv0. By comparing a difference of the tracking voltages of the same test point corresponding to different focus levels, an offset of each tracking voltage is acquired.

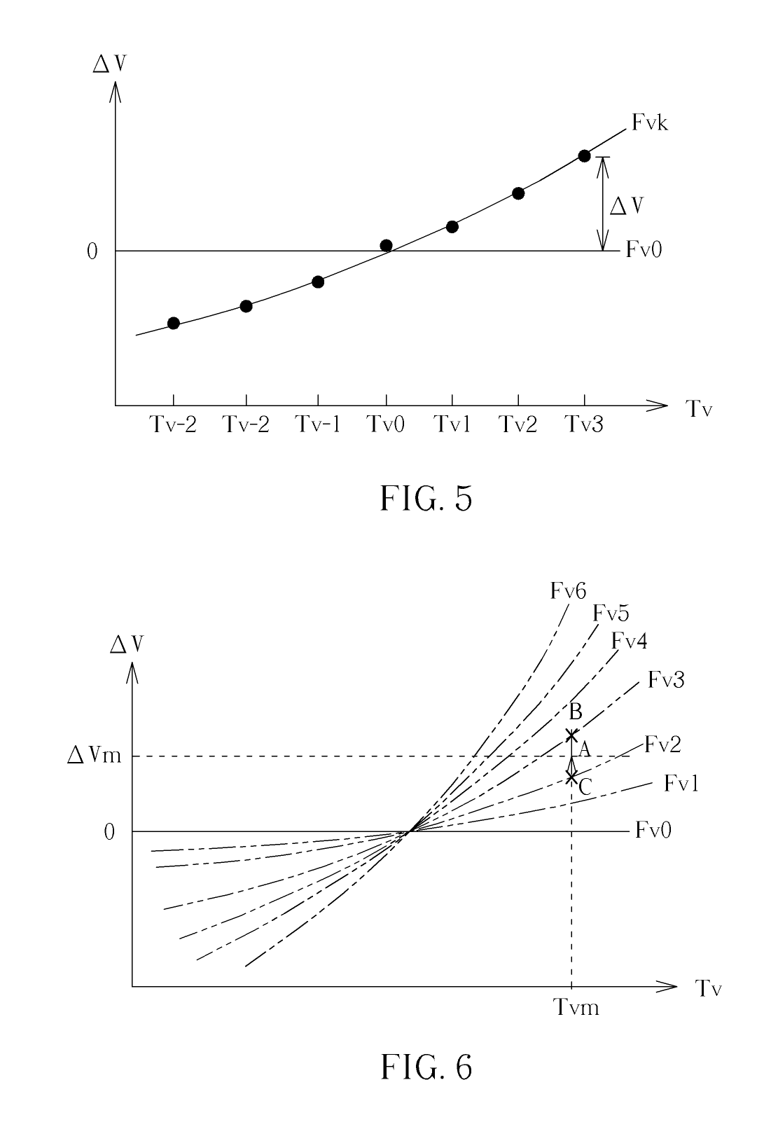

For instance, suppose that the micro actuator 21 needs a tracking voltage Tv3 to shift to the test point P3 at the standard focus voltage level Fv0, but, under a focus voltage level Fvk, the micro actuator 21 cannot move the objective lens 23 to the test point P3 by shifting the same distance by applying the tracking voltage Tv3. In addition, when the focus voltage level is Fvk, a tracking voltage Tvk3 is required for shifting the objective lens 23 to the test point P3. That is, a difference between the tracking voltage Tvk3 and the tracking voltage Tv3 is the offset ΔV, wherein ΔV=Tvk3−Tv3. Please refer to FIG. 5, which illustrates setting the offsets of the test points of each focus voltage level Fvk compared to that of the standard focus voltage level Fv0 as the Y-axis and setting the tracking voltage Tv of the test points compared to the standard focus voltage level Fv0 as the X-axis. By this process, a tracking voltage curve of the focus voltage level Fvk is obtained.

Please refer to FIG. 6; FIG. 6 illustrates a plurality of tracking voltage curves corresponding to each of the focus voltage levels according to an exemplary embodiment of the present invention. By measuring the data of the focus voltage levels having different predetermined heights and comparing them with the data of the standard focus voltage level Fv0 to thereby derive an offset of each tracking voltage of the test points respectively, corresponding tracking voltage curves Fv1, Fv2, Fv3, Fv4, Fv5, and Fv6 are thereby curve-fitted. When the micro actuator drives the objective lens with a tracking voltage Tvm and a focus voltage Fvm at A, an offset ΔVm is acquired according to the tracking voltage Tvm, and two adjacent tracking voltage curves Fv2 and Fv3. More particularly, by interpolating the tracking voltage curves Fv2 and Fv3 and calculating according to the offsets at B and C corresponding to the tracking voltage Tvm, a required offset ΔVm is acquired, wherein the focus voltage Fvm is between the tracking voltage curves Fv2 and Fv3. Then the tracking voltage is calibrated as: tracking voltage=Tvm+ΔVm, to thereby shift the micro actuator to the target location precisely and effectively calibrate the offset of the tracking voltage corresponding to the micro actuator.

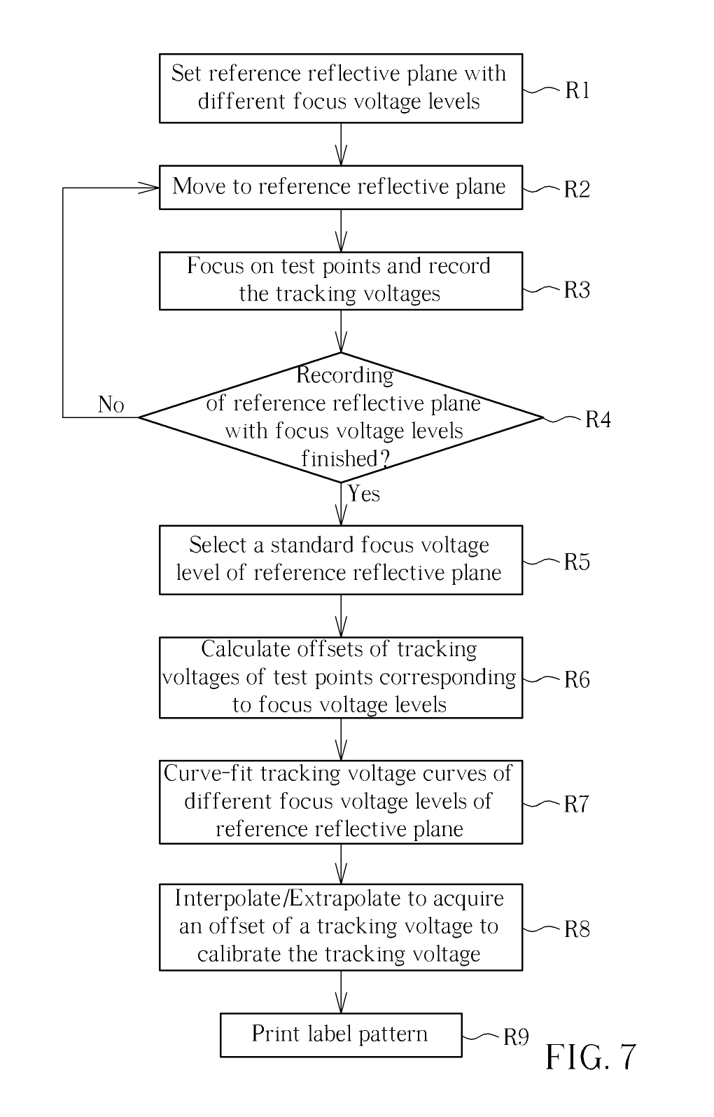

Please refer to FIG. 7; FIG. 7 is a flow chart for calibrating an offset of the micro actuator according to an exemplary embodiment of the present invention. The method applies the tracking voltage curves to calibrate the offset of the tracking voltage of the micro actuator. The flow includes the following steps:

At step R1, the reference reflective plane is set with a plurality of focus voltage levels, and a plurality of test points are set at the reference reflective plane, wherein the distances between each two adjacent test points can be equal or not, according to the design requirements. At step R2, the reference reflective plane is moved to a predetermined height corresponding to a selected focus voltage level. At step R3, the objective lens focuses on each of the predetermined test points at the reference reflective plane respectively, and measures/records the corresponding tracking voltage of each of the test points. At step R4, it is checked whether the measurement of data of the reference reflective plane at each of the set focus voltage levels is finished or not. The flow goes back to the step R2 if the measurement is not finished, the reference reflective plane is moved to another predetermined height, and retains the measurement. If the measurement is finished, the flow goes to the step R5, to select a focus voltage level of the reference reflective plan as the standard focus voltage level according to the data derived in the measurement.

At step R6, an offset of each of the tracking voltage of the test points at other focus voltage levels is derived by a comparison with each of the tracking voltage of the test points at the standard focus voltage. At step R7, the tracking voltage curves corresponding to each of the focus voltages according to the tracking voltages of the standard focus voltage level are curve-fitted with the offset of the tracking voltage corresponding to each of the test points. At step R8, an offset of a driven tracking voltage corresponding to the objective lens is calibrated by acquiring the offset of the driven tracking voltage by interpolating/extrapolating two tracking voltage curves of a corresponding driven focus voltage of the objective lens. At step R9, a label pattern of the label side of the optical disc is printed by applying the calibrated tracking voltage.

In conclusion, by applying the method of the present invention, the accuracy of the label printing is promoted by calibrating an offset of the tracking voltage by interpolating or extrapolating the tracking voltage curves according to the driven tracking voltage and driven focus voltage of the micro actuator, wherein by setting the reference reflective plane at different heights and by setting the test points, the tracking voltage curves are curve-fitted by obtaining offsets of the tracking voltages of each of the test points, and by comparing them with the tracking voltages of the test points of the reference reflective plane at the standard focus voltage level.

It should be noted that using the tracking voltage curves formed by the reference reflective plane at different heights is for illustrative purposes only and is not meant to be a limitation of the present invention. For instance, in other embodiments, the measured data can be used to form a tracking voltage camber; by using the tracking voltage camber, the tracking accuracy of the micro actuator is promoted and the tracking voltage of the micro actuator is compensated by acquiring the offset of the tracking voltage from the tracking voltage camber without interpolation or extrapolation.

Those skilled in the art will readily observe that numerous modifications and alterations of the device and method may be made while retaining the teachings of the invention.

What is claimed is:

1. A method for calibrating an offset of a micro actuator, comprising:
(a) setting a reference reflective plane at a plurality of different focus voltage levels;
(b) focusing on a plurality of test points of the reference reflective plane, and recording a plurality of tracking voltages corresponding to the test points respectively;
(c) selecting a focus voltage level of the focus voltage levels of the reference reflective plane as a standard focus voltage level;
(d) calculating an offset of the tracking voltage for each test point of the reference reflective plane by comparing each focus voltage level with the standard focus voltage level;
(e) curve-fitting the offset of the tracking voltage for each test point into a tracking voltage curve of each of the focus voltage levels, respectively; and
(f) acquiring an offset of a driven tracking voltage by the tracking voltage curve to calibrate the driven tracking voltage.

2. The method of claim 1, wherein the reference reflective plane is a data layer of an optical disc.

3. The method of claim 1, wherein distances between each two adjacent test points of the test points are equidistant.

4. The method of claim 1, wherein distances between each two adjacent test points of the test points are not equidistant.

5. The method of claim 1, wherein focusing the test points of the reference reflective plans in step (b) comprises: focusing at an open-loop tracking.

6. The method of claim 1, further comprising:
(b-1) checking whether recording of the reference reflective plane at different focus voltage levels is finished after executing Step (b); moving the reference reflective plane to another focus voltage level, and going back to Step (b) when the recording is not finished; and going back to Step (c) when the recording is finished.

7. The method of claim 1, further comprising:
selecting a focus voltage having a smallest absolute value as the standard focus voltage level in Step (c).

8. The method of claim 1, further comprising:
selecting a focus voltage having a zero absolute value as the standard focus voltage level in Step (c).

9. The method of claim 1, wherein step (f) interpolates/extrapolates two tracking voltage curves adjacent to a corresponding driven focus voltage corresponding to the driven tracking voltage, for acquiring the offset of the driven tracking voltage and calibrating the offset of the driven tracking voltage.

10. The method of claim 1, further comprising: printing a label pattern of a label side of an optical disc after calibrating the driven tracking voltage.
